(19) United States
(12) Patent Application Publication
(10) Pub. No.: US 2024/0385819 A1
(43) Pub. Date: Nov. 21, 2024

(54) Method and System for Dynamically Optimizing Native Application that is Statically Compiled Particularly on Cloud

(71) Applicant: Rouhollah Gougol, San Ramon, CA (US)

(72) Inventor: Rouhollah Gougol, San Ramon, CA (US)

(21) Appl. No.: 17/814,528

(22) Filed: Jul. 24, 2022

(51) Int. Cl. G06F 8/41

(52) U.S. Cl. CPC G06F 8/4441

(57) ABSTRACT

Native applications and executable code are compiled by static compilers and lack dynamic optimization that Just-in-Time compilation can provide to interpretive languages such as Java. Just-In-Time compilation of native code can provide dynamic optimization for such applications. A particular optimization is dynamic auto-distribution, and this is more special in cloud environments due to its dynamic nature. The auto-distribution can be from on-premises to cloud as an application running natively in computer, the Just-In-Time compiler sprays part of it to cloud and further performs more dynamic optimization in rounds. The Just-in-Time compilation is not replacing static compilation but provides hybrid of static optimization and dynamic optimization and it is contrary to existing field that uses hybrid of interpretation and dynamic compilation.

### FIELD OF THE INVENTION

The present invention relates to digital data processing, and specifically for cloud-based digital data processing environments providing a just-in-time compiler. It also relates to on-premises digital data processing environments and digital data processing environments of on-premises connected to cloud providing a just-in-time compiler. It relates to digital data processing where static compiler is already used and provides just-in-time compiler as extra optimization.

### BACKGROUND

Many application and software products are compiled by a static compiler into native code. The most prominent example might be C++ language, which is heavily used in system programming, operating systems, virtual machines, etc. On the other hand, there are many interpretive languages like Java and Python which are compiled into bytecode and a framework interpret them and/or just-in-time compile them into native code. Here the problem with static compilers like C++ compiler is they miss a huge amount of dynamic optimization and advanced memory management and garbage collection that interpretive languages use.

One example of dynamic optimization in such framework is to dynamically profile software in field. Just-in-time compiler can dynamically take advantage of those to optimize software appropriated to specific execution. Static compiler also has capacity to profile execution code but majority of software developers and release engineers just as the matter of fact do not bother with that. Even in such static profiling, the statistics will be based on sample, and it will not be real and won't be dynamic on fly.

Another significant advantage of dynamic compiler over static compiler is that in many cases static compiler can't perform optimization because it can't be sure of feasibility. Even if a huge optimization is with probability of 99.9% feasible, static compiler goes the other way and avoids it. Dynamic compiler easily achieves 100% sureness by accessing on-fly parameters and data and monitoring them. Even if dynamic compiler is 60% sure of an optimization, it can just execute it and monitor and reverse it as soon as the optimization becomes invalid.

To solve such problems and take advantage of dynamic optimization for languages with native execution, Apple company produced a compiler called LLVM which like interpretive languages compiled C++ application to byte code and then JIT it. The problems with this approach were so numerous and static compilers of C++ like GCC, and Intel C++ compiler were still extremely popular. Apple company eventually converted LLVM compiler to a static compiler like GCC.

Even if LLVM succeeded as JIT compiler, one problem would be that users must install LLVM framework and go through all configurations. Also, the application would have a delay. The overhead of the framework and compilation before execution at startup might be obvious to the user. All developers also should go through the pain of migrating the compiler.

Regarding cloud, evolution of isolated computers to networked devices and shared information has proceeded to a further stage in digital data processing. The “cloud” is in fact a collection of computing hardware and software resources which are accessible from remote locations to perform useful work on behalf of a client. However, except for the access point, such as a client computer terminal having limited capability, the client does not own or control hardware and software resources which provide computing services in cloud. The cloud presents a virtualized system having the capability to provide whatever computing services are required. The client contracts to obtain the computing services. These services are provided by the virtualized system, i.e., without any specification of the physical computer systems which will provide the contracted service. This virtualization enables a provider of services in cloud to re-allocate the physical computer resources as convenient, without involvement of the client. Cloud computing has thus been analogized to an electric utility, in which the customer purchases electric power without any knowledge or concern how the power is generated. Cloud computing enables the entire computing task to be performed remotely. On-premises environment also may be connected to cloud using VPN and other technologies.

The advantage of portability inherent in dynamic compilation makes it particularly useful in many cloud computing environments because the actual physical machine which will execute a given task is not generally known in advance, and hence the instruction set and other parameters of the processor or processors executing the task are unknown. A dynamic compiler can potentially generate the executable code at a time when the required binary instruction set format is known.

What else is significantly dynamic in cloud environments is the number of resources. The amount of resources can even reach zero afterhours in environment where on-premises is connected to cloud. The amount also can reach as much as a mini supercomputer or beyond during peak hours. Obviously, static compiler and static optimization would be suboptimal.

With the growth in cloud computing, it is desirable to adopt the compilation of computer programming code to a cloud environment in an optimal manner, and to provide enhanced techniques for dynamic programming code compilation which take advantage of, and operate efficiently within, cloud computing environment.

Dynamic optimization is special in cloud computing but by no means limited to that. Stand-alone on-premises and proprietary datacenter and even single desktop computer can take advantage of dynamic optimization explained above. Such environment can also be sometimes isolated and sometimes connected to the cloud.

### SUMMARY

A cloud computing environment supports execution of application code specified by multiple clients. Each client accessing cloud services may be allocated a respective virtual machine, the characteristics of each virtual machine varying in accordance with defining parameters which are, at least in part, specified by the corresponding client. A client may also enjoy other cloud services such as duckers or serverless functionalities (lambda). An on-premises computing environment also supports execution of application code specified by multiple clients. On-premises environment can be connected to cloud and access cloud services.

This invention presents a just-in-time compiler that dynamically optimizes applications that are running in native code in cloud or on-premises. Dynamic optimization typically starts with auto-distribution and follows with further dynamic optimization. Dynamics of optimization and auto-distribution is particularly more important about cloud as the resources can dynamically increase and decrease and on-premises may even get totally disconnected from cloud at some afterhours time.

Applications that are native are compiled by static compilers and lack such dynamic optimization. Even applications that are developed by interpretive languages like Java that also do enjoy dynamic optimization, have their virtual machine in native code and the virtual machine is compiled statically. This invention can add dynamic optimization for them by dynamically optimizing the virtual machine. Besides, barely even any Just-in-Time compiler for Java or any language spray part of the code from on-premises to cloud.

The invention does not intend to replace static compilation with dynamic compilation. It provides hybrid of static compilation and just-in-time compilation to provide both static and dynamic optimization and keep advantages of static compilers and native and executable code. Even in field, just-in-time compiler is barely used alone, and it is in hybrid mode of interpretation and dynamic compilation where this invention is a hybrid of native execution and dynamic optimization.

The details of the present invention, both as to its structure and operation, can best be understood in reference to the accompanying drawings, in which like reference numerals refer to like parts, and in which:

### BRIEF DESCRIPTION OF THE DRAWING

FIG. 1 is a high-level conceptual representation of the overall process of dynamic optimization according to one or more preferred embodiments of the present invention.

FIG. 2 is a high-level illustration of the representative profiling that the dynamic optimization performs as part of, in accordance with one or more preferred embodiments.

FIG. 3 is a high-level block diagram of the statistics that the dynamic optimization profiles and collects, according to the preferred embodiment.

FIG. 4 is a conceptual illustration showing the enhancement analysis the dynamic optimization performs, according to the preferred embodiment.

FIG. 5 is a conceptual illustration of optimization analysis the dynamic optimization performs, according to the preferred embodiment.

FIG. 6 is a conceptual illustration of tracing as one significant dynamic optimization, according to the preferred embodiment.

FIG. 7 is a conceptual illustration of the classic optimization the dynamic optimization executes against target application, according to the preferred embodiment.

FIG. 8 is a conceptual illustration of auto parallelization and auto distribution as significant dynamic optimization, according to the preferred embodiment.

FIG. 9 is a conceptual illustration of enhancements of distribution and parallelization optimization of FIG. 8, according to the preferred embodiment.

FIG. 10 is a conceptual illustration of the resource management as significant dynamic optimization, according to the preferred embodiment.

FIG. 11 is a conceptual illustration of memory management as significant dynamic optimization, according to the preferred embodiment.

FIG. 12 is a conceptual illustration of garbage collection as significant dynamic optimization, according to the preferred embodiment.

FIG. 13 is a conceptual illustration of on-premises network and cloud which are the environment where an application executes, and the dynamic optimization enhances the application and cuts and sprays parts of the application over the resources. All or any of resources on on-premises or cloud can be used as a backend resource that the dynamic optimization takes advantage of, according to the preferred embodiment.

FIG. 14 is a flow diagram illustrating at an elevated level the process of changing the defining parameters of an application and backend resource executing in cloud, according to the preferred embodiment.

FIG. 15 is a flow diagram illustrating at an elevated level the operation of optimizing application incrementally considering load of the backend resource and what is already optimized, according to the preferred embodiment.

### DETAILED DESCRIPTION

In accordance with one or more preferred embodiments of the present invention, certain improvements are made to computer program efficiency in a cloud computing environment, and particularly to the efficiency of programs using Just-In-Time (JIT) compilation in such an environment. The environment can also be on-premises connected to cloud or stand-alone on-premises.

Cloud computing involves the use of on-demand computing resources which are accessed remotely, i.e., over a network, by a client's digital computing device. The client does not request the use of specific computing devices, but requests computing services defined in some standardized form. For example, the client may request some processor capacity and/or memory capacity, using standardized measures of processor and/or memory. Alternatively, the client may request that application programs be executed and/or that particular input data be processed, the amount of processor and/or memory capacity being assumed or derived according to the application and data processing service requested. The request may specify, implicitly or explicitly, a response time, schedule, or other parameters with respect to when the requested work is performed, or resources are provided. The amount of computing resource requested by the client may change from time to time.

Cloud includes a collection of hardware and software computing resources accessible through one or more networks. In general, these resources are sufficient to meet changing demands from multiple clients. Cloud has therefore been analogized to an electric utility, which provides electric power on demand to multiple customers. Customers do not request that electric power be generated by specific generation equipment or transmitted over specific lines, and in general customers have no way of knowing which specific generation and transmission equipment is used. Similarly, a cloud provides computing services to its clients on demand, without the client specifying or knowing which particular digital computing devices are providing the requested service.

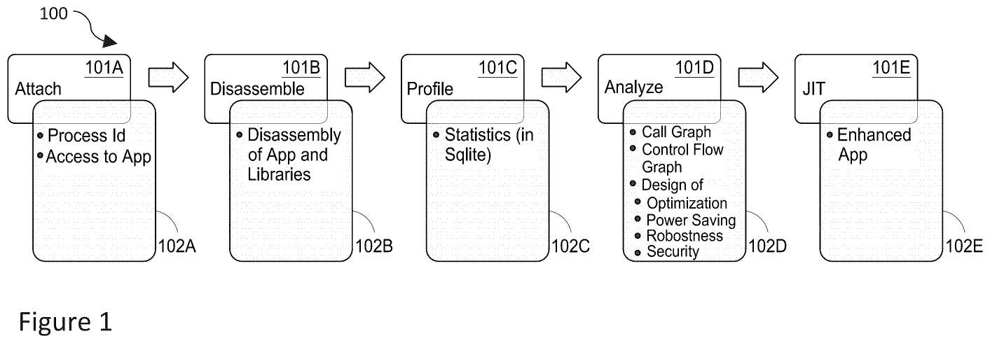

Referring to the drawing, wherein like numbers denote like parts throughout the several views, FIG. 1 is a high-level conceptual representation of the overall process of dynamic optimization according to one or more preferred embodiments of the present invention. Multiple stages of dynamic optimization 101A, 101B, 101C (herein generically referred to as feature 101) access target application in cloud 1301 or in on-premises 1302. The dynamic optimization or the dynamic optimizer 101 executes optimization against the target application as it will be explained in detail.

Attaching 101A to the process means telling the CPU to send the instructions in the executable code to the dynamic optimizer 101 before they are executed by the CPU. In other words, you place the dynamic optimizer 101 between the executable code and the CPU. Process identifier, also known as process ID 102A or PID, is a unique number to identify each process running in an operating system such as Linux, Windows, and Unix. PIDs are reused over time and can only identify a process during the lifetime of the process, so it does not identify processes that are no longer running. In programming terminology, to disassemble 101B is to convert a program in its executable (ready-to-run) form (sometimes called object code) into a representation in some form of assembler language so that it is readable by a human.

In the information sciences, to profile 101C an application consists of a set of metadata elements, policies, and guidelines defined for a particular application. The analyze 101D phase creates an intermediate representation from the given source code. A call graph 102D (also known as a call multigraph) is a control-flow graph, which represents calling relationships between subroutines in a computer program. A Control Flow Graph 102D (CFG) is the graphical representation of control flow or computation during the execution of programs or applications. Control flow graphs are mostly used in static analysis as well as compiler applications, as they can accurately represent the flow inside of a program unit.

Optimization 102D tries to minimize or maximize some attributes of an executable computer program. Common requirements are to minimize a program's execution time, memory footprint, storage size, and power consumption (the last three being popular for portable computers). The power consumption of a CPU is determined primarily by operating frequency, which is then determined by usage. Usage in this case refers to processing power demand (CPU utilization). As a result of this, video games and other CPU-intensive apps will increase PCs power consumption. Power saving 102D refers to reducing the consumption.

Software robustness 102D is a quality check that helps in identifying whether the software is tolerant to all kinds of faults or not. Based on their source, robustness analysis can classify faults into three types. First, hardware fault-such as disk failure or failure of a telecommunication line, etc. Second, software fault-such as a bug in the software. Third, user fault-entering the data in a different format than expected. Software security 102D is the concept of implementing mechanisms in the construction of security to help it remain functional (or resistant) to attacks. This means that a piece of software undergoes software security testing before going to market to check its ability to withstand malicious attacks.

Just-in-time (JIT) 101E compilation (also dynamic translation or run-time compilations) is a way of executing computer code that involves compilation during execution of a program (at run time) rather than before execution. This may consist of source code translation but is more commonly bytecode translation to machine code, which is then executed directly. A system implementing a JIT compiler typically continuously analyzes the code being executed and identifies parts of the code where the speedup gained from compilation or recompilation would outweigh the overhead of compiling that code.

JIT 101E compilation is a combination of the two traditional approaches to translation to machine code-ahead-of-time compilation (AOT), and interpretation—and combines some advantages and drawbacks of both. JIT compilation combines the speed of compiled code with the flexibility of interpretation, with the overhead of an interpreter and the additional overhead of compiling and linking (not just interpreting). JIT compilation is a form of dynamic compilation and allows adaptive optimization such as dynamic recompilation and microarchitecture-specific speedups. Interpretation and JIT compilation are particularly suited for dynamic programming languages, as the runtime system can handle late-bound data types and enforce security guarantees.

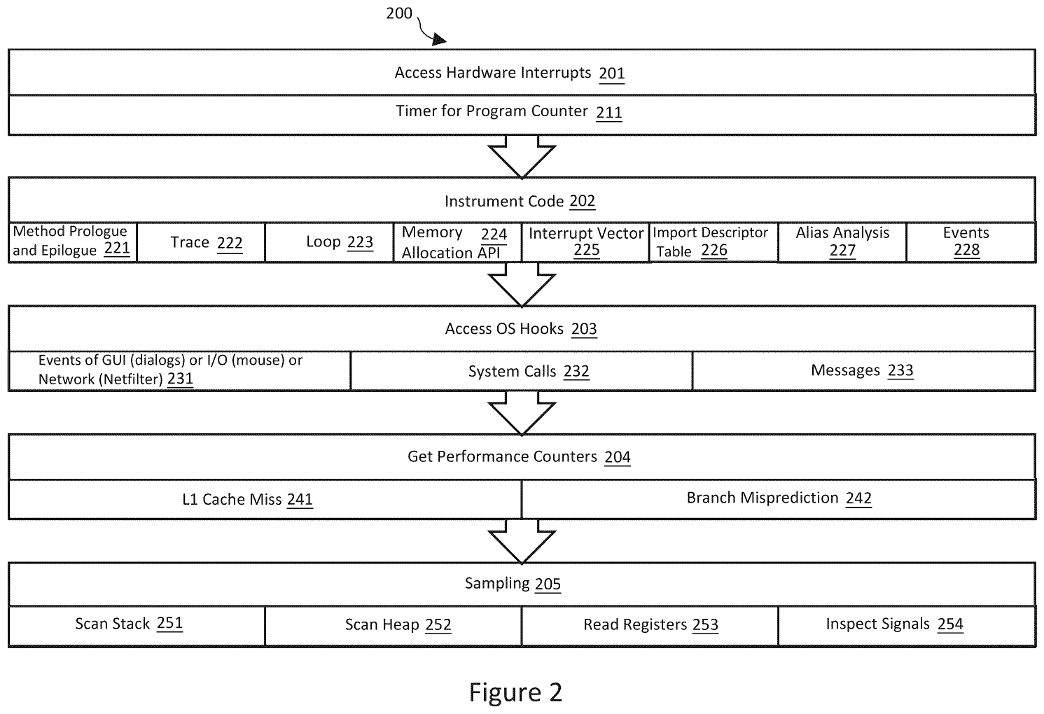

FIG. 2 is a high-level illustration of the representative profiling that the dynamic optimization performs as part of, in accordance with one or more preferred embodiments. A hardware interrupt 201 is an electronic alerting signal sent to the processor from an external device, like a disk controller or an external peripheral. For example, a key press on the keyboard or move of the mouse triggers hardware interrupts which cause the processor to read the keystroke or mouse position. Profilers can analyze both application and OS performance, relying on timer interrupts to generate their samples. The data is obtained by having a hardware timer 211 generate regular interrupts. The interrupt handler stores the program counter 211 of the interrupted code. The profiler performs a statistical analysis of the resulting data and works out where the time was spent.

With Instrument Code 202, every function call in application can be annotated and instrumented so that when it gets invoked it is added to the trace along with information about the caller. The value of instrumentation profiling is that can get exact call counts on how many times functions were called. This gives much more detailed information than normal sampling profiling cost of distorting the time taken in some scenarios. For example, functions that do not do much, but are called frequently will show up more than they would in the real world.

A programming OS hook 203 is a subroutine that intercepts some call in the operating system and diverts it to a different program path. Hooking covers a range of techniques used to alter or augment the behavior of an operating system, of applications, or of other software components by intercepting function calls or messages or events passed between software components. Code that handles such intercepted function calls, events or messages is called a hook. GUI event 231 is an object that represents a user's interaction with a GUI component; can be “handled” to create interactive components, can be considered an OS hook. Linux provides another example where hooks can be used in an analogous manner to process network events 231 within the kernel through Net Filter.

A system calls 232 is the programmatic way in which a computer program requests a service from the kernel of the operating system it is executed on. System call provides the services of the operating system to the user programs via Application Program Interface (API). System calls are the only entry points into the kernel system. All programs needing resources must use system calls.

Performance Counters 204 provide a high-level abstraction layer that provides a consistent interface for collecting various kinds of system data such as CPU, memory, and disk usage. System administrators often use performance counters to monitor systems for performance or behavior problems. A cache-miss 241 is an event in which a system or application makes a request to retrieve data from a cache, but that specific data is not currently in cache memory. Contrast this to a cache hit, in which the requested data is successfully retrieved from the cache. Branch prediction is another item of performance count. The time that is wasted in case of a branch misprediction 242 is equal to the number of stages in the pipeline from the fetch stage to the execute stage.

The sampling 205 profiler makes a quick overall look at the application's performance. It polls the profiled application at certain intervals and determines the routine that is currently being executed. It increases the sample count for that routine and reports the number of collected samples in results. In other words, it reports the number of times a routine was found executed during the application run. The profiler also reports approximate time spent on the routine's execution.

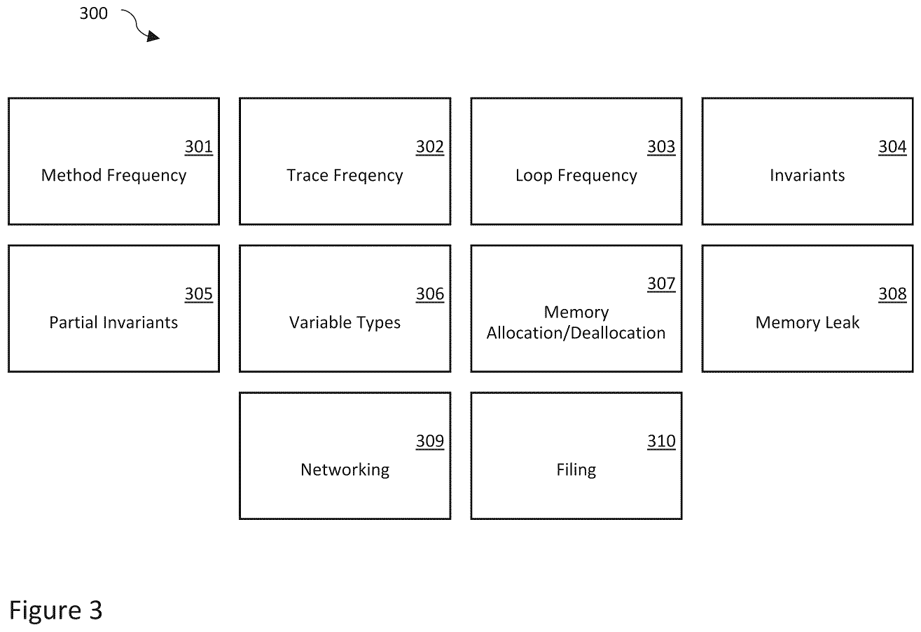

FIG. 3 is a high-level block diagram of the statistics that the dynamic optimization profiles and collects, according to the preferred embodiment. Frequency, such as Method Frequency 301, is a vital profiling used to discover the common and uncommon values in the data. The results of frequency profiling can build reference lists of valid and invalid values for each data attribute, for use in validation. Invariants 304, quite literally, mean something that do not change or vary. It can be seen as a set of assumptions a piece of code takes before it is able to perform any computation of importance. A loop invariant 304 is a property of a program loop that is true before (and after) each iteration.

A memory leak 308 is a type of resource leak that occurs when a computer program incorrectly manages memory allocations. A memory leak 308 is the gradual deterioration of system performance that occurs over time as the result of the fragmentation of a computer's RAM due to poorly designed or programmed applications that fail to free up memory segments when they are no longer needed.

Networking 309 refers to interconnected computing devices that can exchange data and share resources with each other. These networked devices use a system of rules, called communications protocols, to transmit information over physical or wireless technologies. A computerized or electronic filing 310 system organizes and stores business's files on a hard drive or network space. The system can be software- or internet-based, or a simple desktop folder/file system on a computer.

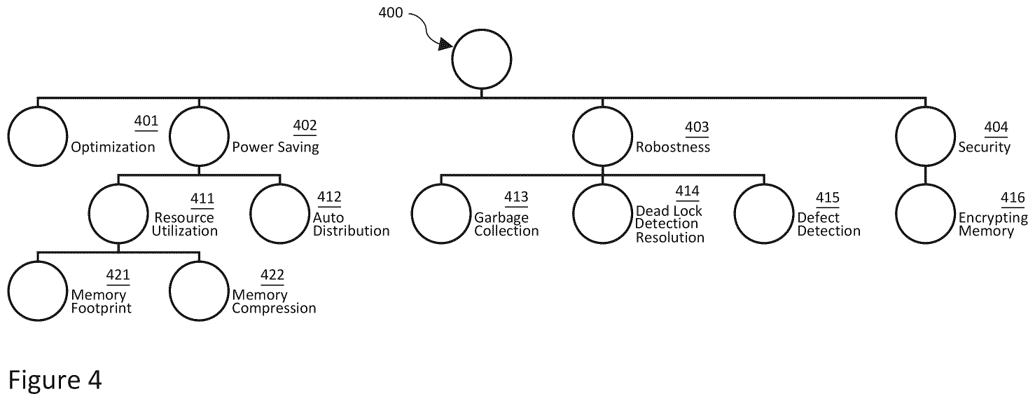

FIG. 4 is a conceptual illustration showing the enhancement analysis the dynamic optimization performs, according to the preferred embodiment. Resource utilization 411 is a way to track how busy various resources of a computer system are when running a performance test. Memory footprint 421 refers to the amount of main memory that a program uses or references while running. Data compression 422 is a reduction in the number of bits needed to represent data. Compressing data can save storage capacity, speed up file transfer, and decrease costs for storage hardware and network bandwidth. Garbage collection 413 (GC) is a form of automatic memory management. The garbage collector attempts to reclaim memory which was allocated. A deadlock 414 is a situation in which two computer programs sharing the same resource are effectively preventing each other from accessing the resource, resulting in both programs ceasing to function.

A software bug, defect 415, is an error, flaw or fault in the design, development, or operation of computer software that causes it to produce an incorrect or unexpected result, or to behave in unintended ways. Bugs in software can arise from mistakes and errors made in interpreting and extracting users' requirements, planning a program's design, writing its source code, and from interaction with humans, hardware, and programs, such as operating systems or libraries. Encrypting 416 is the method by which information is converted into secret code that hides the information's true meaning.

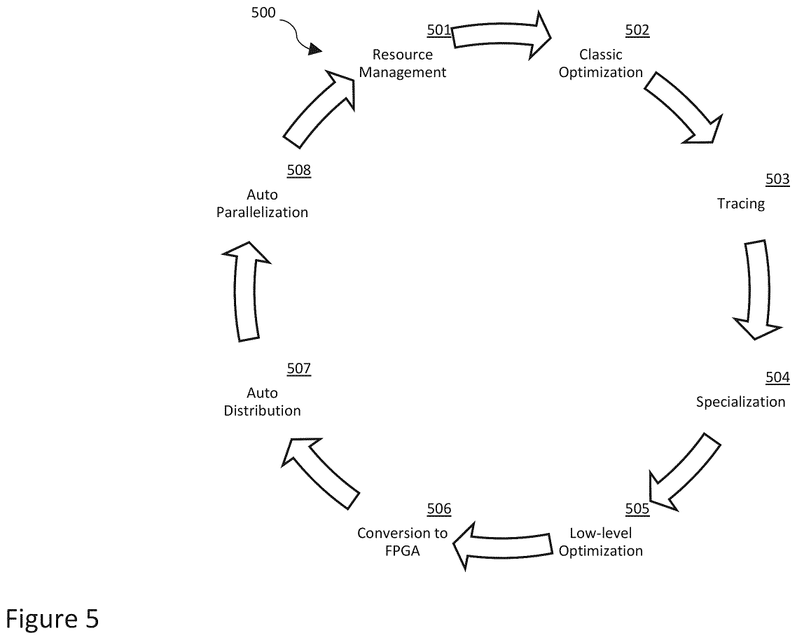

FIG. 5 is a conceptual illustration of optimization analysis the dynamic optimization performs, according to the preferred embodiment. Resource management 501 refers to techniques for managing resources (components with limited availability). The classic optimization 502 in the synthesis phase is a program transformation technique, which tries to improve the intermediate code by making it consume fewer resources (i.e., CPU, memory) so that faster-running machine code will result. Tracing 503 is done by recording a linear sequence of frequently executed operations, compiling them to native machine code and executing them. Code specialization 504 is a technique used to generate more efficient code for a specific purpose from generic code. The core issue of code specialization is the prediction of effective code-behavior to generate precise control-flows.

Low-level optimization 505 or platform-dependent techniques involve instruction scheduling, instruction-level parallelism, data-level parallelism, cache optimization techniques (i.e., parameters that differ among various platforms) and the optimal instruction scheduling might be different even on different processors of the same architecture. FPGA 506 stands for field-programmable gate array. That is quite a mouthful, so let us start with a basic definition. An FPGA is a hardware circuit that a user can program to carry out one or more logical operations. Distributed computing is a model in which components of a software system are shared among multiple computers. Even though the components are spread out across multiple computers, they are run as one system. This is done to improve efficiency and performance.

Auto Distribution 507 refers to that compiler converts and optimizes software in this way. Automatic parallelization 508, or auto-parallelization refers to converting sequential code into multi-threaded and/or vectorized code in order to use multiple processors simultaneously in a shared-memory multiprocessor (SMP) machine. Fully automatic parallelization of sequential programs is a challenge because it requires complex program analysis, and the best approach may depend upon parameter values that are not known at compilation time.

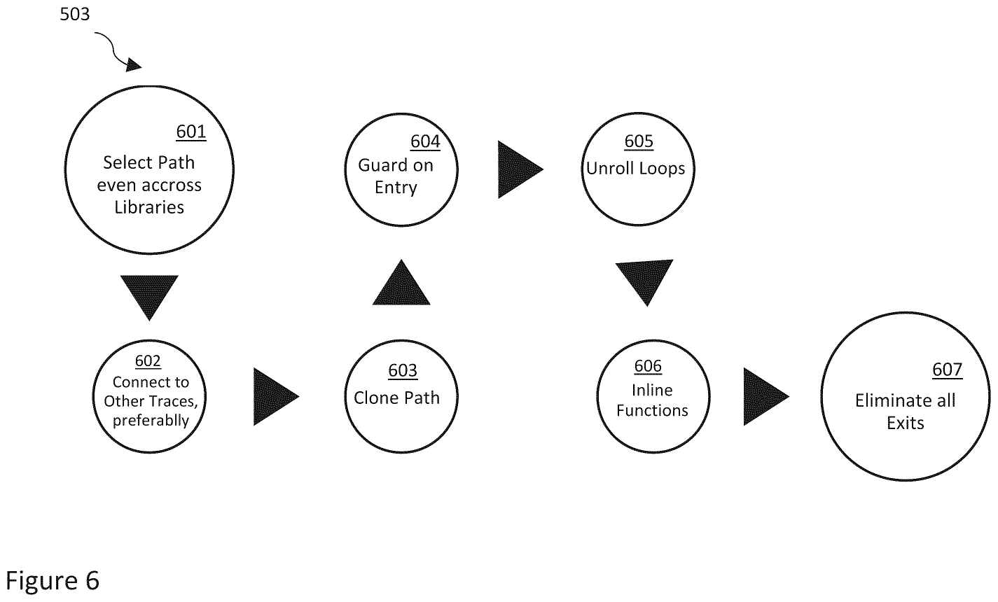

FIG. 6 is a conceptual illustration of tracing as one significant dynamic optimization, according to the preferred embodiment. Loop unrolling 605, also known as loop unwinding, is a loop transformation technique that attempts to optimize a program's execution speed at the expense of its binary size, which is an approach known as space-time tradeoff. The transformation can be undertaken manually by the programmer or by an optimizing compiler. On modern processors, loop unrolling is often counterproductive, as the increased code size can cause more cache misses. An inline function 606 is one for which the compiler copies the code from the function definition directly into the code of the calling function rather than creating a separate set of instructions in memory. This eliminates call-linkage overhead and can expose significant optimization opportunities.

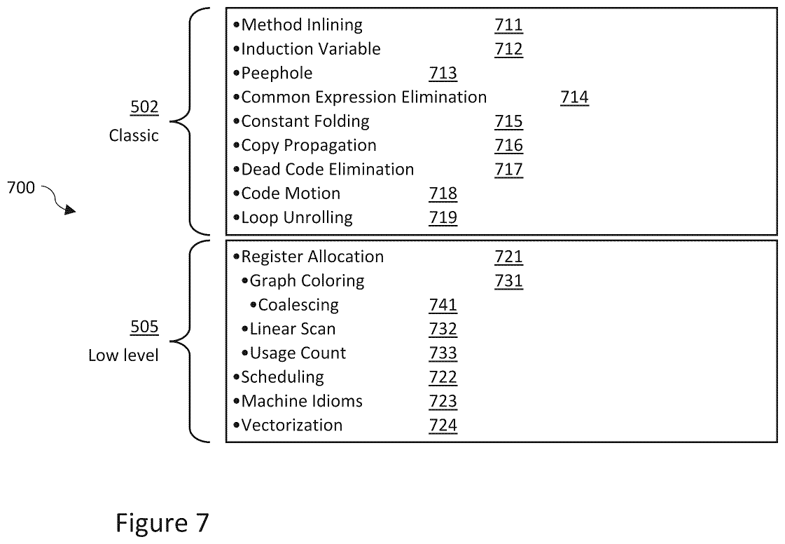

FIG. 7 is a conceptual illustration of the classic optimization the dynamic optimization executes against target application, according to the preferred embodiment. An induction variable 712 is a variable that gets increased or decreased by a fixed amount on every iteration of a loop. Peephole 713 optimization is a type of code optimization performed on a small part of the code, on an exceedingly small set of instructions. Common subexpression elimination 714 (CSE) is a compiler optimization that searches for instances of identical expressions (i.e., they all evaluate to the same value), and analyzes whether it is worthwhile replacing them with a single variable holding the computed value.

Constant folding 715 is an optimization technique that eliminates expressions that calculates a value that can already be determined before code execution. These are typically calculations that only reference constant values or expressions that reference variables whose values are constant. Copy propagation 716 is the process of replacing the occurrences of targets of direct assignments with their values. Dead Code Elimination 717 is an optimization that removes code which does not affect the program results. Dead code even can easily creep into large, long-lived programs even at the source code level. Loop-invariant code motion 718 (also called hoisting or scalar promotion) is a compiler optimization which performs this movement automatically.

Register allocation 721 is the process of assigning local automatic variables and expression results to a limited number of processor registers. Instruction scheduling 722 is a compiler optimization used to improve instruction-level parallelism, which improves performance on machines with instruction pipelines. Put more simply, it tries to do the following without changing the meaning of the code: Avoid pipeline stalls by rearranging the order of instructions. Idioms 723 are frequently occurring expressions that programmers use for logically primitive operations for which no primitive construct is available in the language. Automatic vectorization 724, in parallel computing, is a special case of automatic parallelization, where a computer program is converted from a scalar implementation, which processes a single pair of operands at a time, to a vector implementation, which processes one operation on multiple pairs of operands at once.

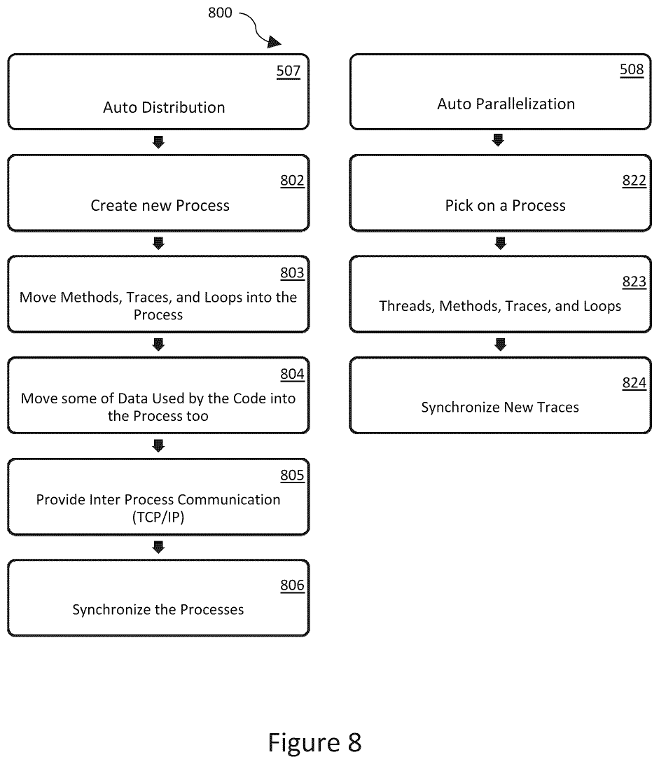

FIG. 8 is a conceptual illustration of auto parallelization and auto distribution as significant dynamic optimization, according to the preferred embodiment. Operating system provides mechanisms for facilitating communications and data sharing between applications. Collectively, the activities enabled by these mechanisms are called inter-process communications 805 (IPC). Process Synchronization 806 is the task of coordinating the execution of processes in a way that no two processes can have access to the same shared data and resources.

Some forms of IPC facilitate the division of labor among several specialized processes. TCP/IP 805 stands for Transmission Control Protocol/Internet Protocol and is a suite of communication protocols used to interconnect network devices on the internet. TCP/IP is also used as a communications protocol in a private computer network (an intranet or extranet). The entire IP suite—a set of rules and procedures—is commonly referred to as TCP/IP 805. TCP and IP are the two main protocols, though others are included in the suite. The TCP/IP protocol suite functions as an abstraction layer between internet applications and the routing and switching fabric.

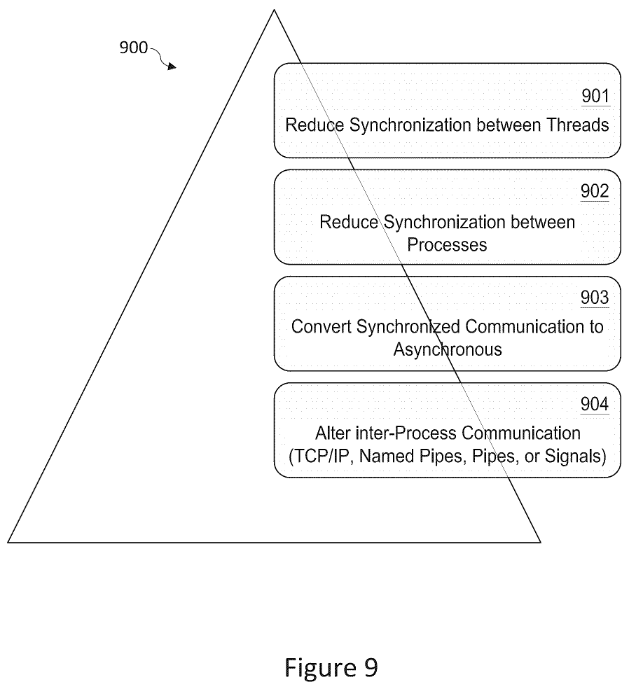

FIG. 9 is a conceptual illustration of enhancements of distribution and parallelization optimization of FIG. 8, according to the preferred embodiment. Asynchronous 904 means of or requiring a form of computer control timing protocol in which a specific operation begins upon receipt of an indication (signal) that the preceding operation has been completed. Usually, asynchronous code makes sense when the operation in consideration might invoke some Input Output operations (file system read/write, network or web access, database access . . . etc.). If a method reads some data from a file using synchronous methods and then does some CPU work on the contents of such file, then convert 903 the method to be asynchronous.

A Pipe 904 is a technique used for inter-process communication. A pipe is a mechanism that directs the output of one process into the input of another process. Thus, it provides one way flow of data between two related processes. Named pipe 904 is meant for communication between two or more unrelated processes and can also have bi-directional communication. Named pipes 904 can provide communication between processes on the same computer or between processes on different computers across a network. If the server service is running, all named pipes are accessible remotely. A signal 904 is a notification to a process indicating the occurrence of an event. Another term for signal is software interrupt.

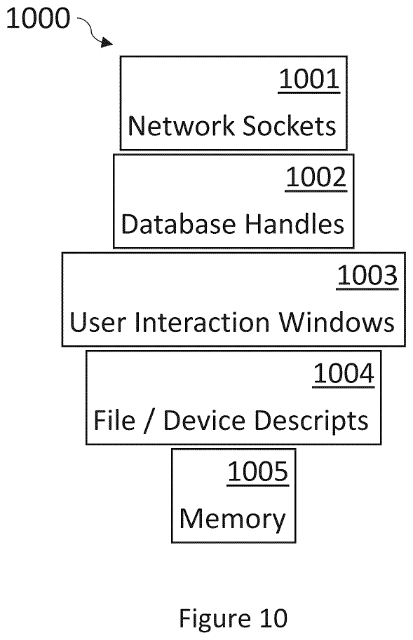

FIG. 10 is a conceptual illustration of the resource management as significant dynamic optimization, according to the preferred embodiment. Computer memory 1005 is the storage space in the computer, where the computer processes data and instructions required for processing are stored. The memory is divided into substantial number of small parts called cells. Each location or cell has a unique address, which varies from zero to memory size minus one. Memory 1005 management is the functionality of an operating system which handles or manages primary memory and moves processes back and forth between main memory and disk during execution. Memory management keeps track of each memory location, regardless of either it is allocated to some process, or it is free.

A network socket 1001 is a software structure within a network node of a computer network that serves as an endpoint for sending and receiving data across. Database handles 1002 are the first step towards doing work with the database, in that they encapsulate a single connection to a particular database. Interaction 1003 is the variety of ways users interact with your app, including touch, keyboard, mouse, and so on. A file descriptor 1004 is a number that uniquely identifies an open file in a computer's operating system. It describes a data resource, and how that resource may be accessed.

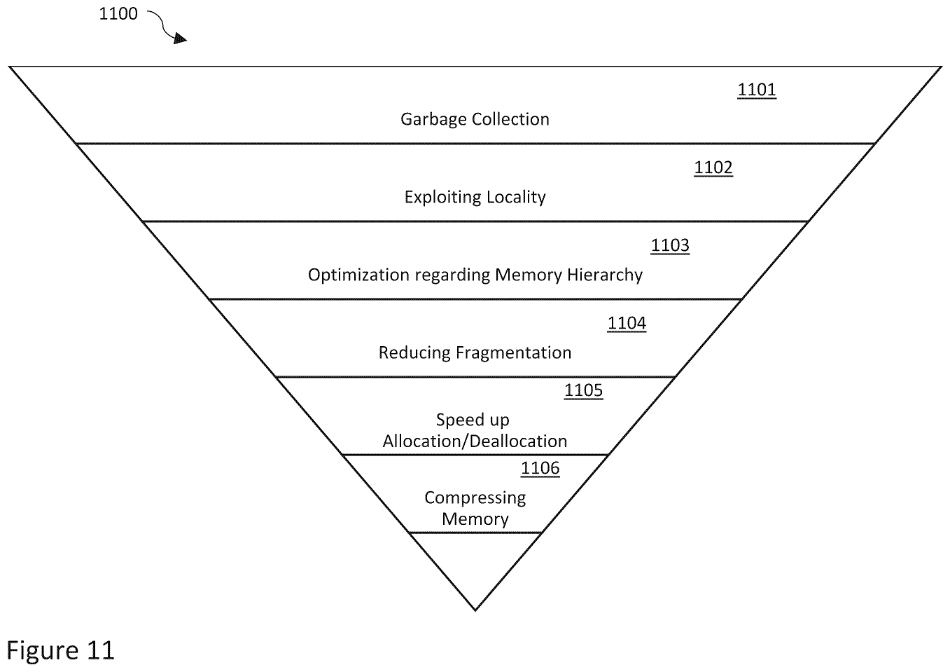

FIG. 11 is a conceptual illustration of memory management as significant dynamic optimization, according to the preferred embodiment. Locality 1102 of reference, also known as the principle of locality, is the tendency of a processor to access the same set of memory locations. The memory hierarchy 1103 separates computer storage into a hierarchy based on response time. As processes are loaded and removed from memory, the free memory space is broken into little pieces. It happens after sometimes that processes cannot be allocated to memory blocks considering their small size and memory blocks remains unused. This problem is known as Fragmentation 1104.

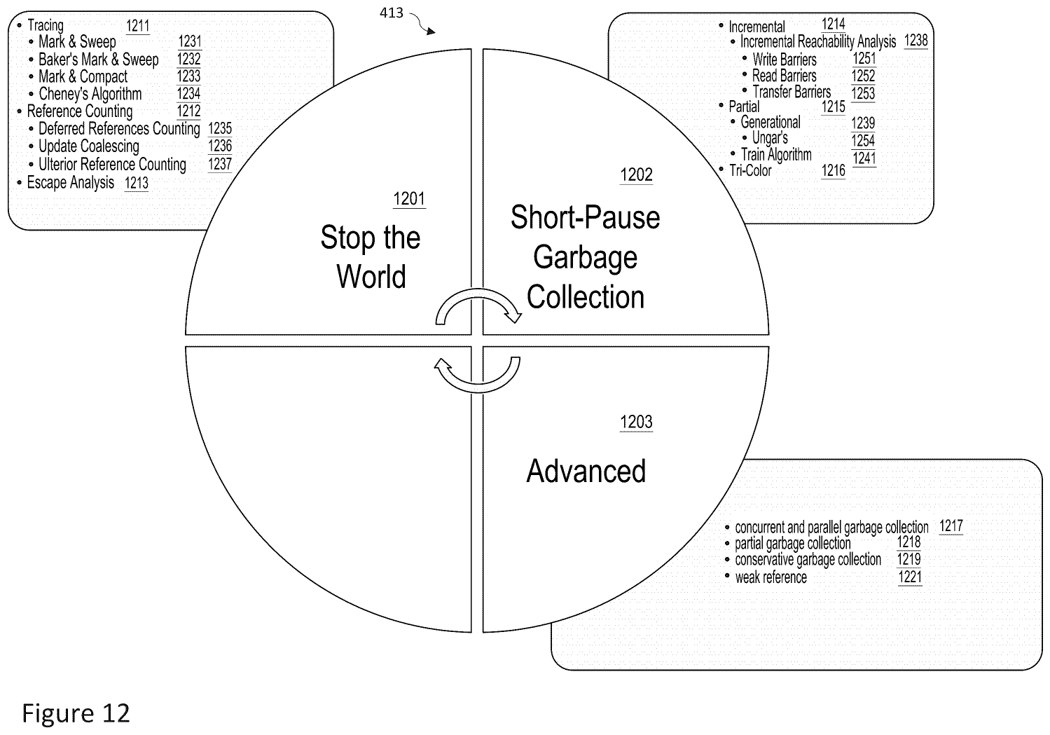

FIG. 12 is a conceptual illustration of garbage collection as significant dynamic optimization, according to the preferred embodiment. All minor garbage collections are “Stop the World” 1201 events. This means that all application threads are stopped until the operation completes. Minor garbage collections are always Stop the World events. The Old Generation is used to store long surviving objects. Instead of collecting garbage as it is created, trace-based 1211 collectors run periodically to find unreachable objects and reclaim their space. Reference counting 1212 garbage collection is where each object has a count of the number of references to it. Garbage is identified by having a reference count of zero. An object's reference count is incremented when a reference to it is created and decremented when a reference is destroyed. Escape analysis 1213 is a method for determining the dynamic scope of pointers—where in the program, a pointer can be accessed. It is related to pointer analysis and shape analysis.

Short-Pause Garbage Collection 1202 reduces the impact of GC “stop-the-world” phases and improves the throughput and consistency of response. An incremental 1214 garbage collector is any garbage-collector that can run incrementally (meaning that it can do a little work, then some more work, then some more work), instead of having to run the whole collection without interruption. A Partial 1215 Garbage Collection (PGC) reclaims memory by using either a Copy-Forward or Mark-Compact operation. Tricolor 1216 marking is a tracing garbage collection algorithm that assigns a color (black, white, or gray) to each node in the graph. It is basic to incremental garbage collection. Initially all nodes are colored white. The distinguished root set is colored gray.

The parallel collector 1217 (also referred to as the throughput collector) is a generational collector like the serial collector; the primary difference is that multiple threads are used to speed up garbage collection. A garbage collector is called conservative 1219 if it can operate with minimal information about the layout of the client program's data. For conservative collectors, the most apparent potential source of excess memory retention is pointer misidentification (e.g., misidentifying integers as pointers). A weak reference 1221 permits the garbage collector to collect the object while still allowing the application to access the object. A weak reference is valid only during the indeterminate amount of time until the object is collected when no strong references exist.

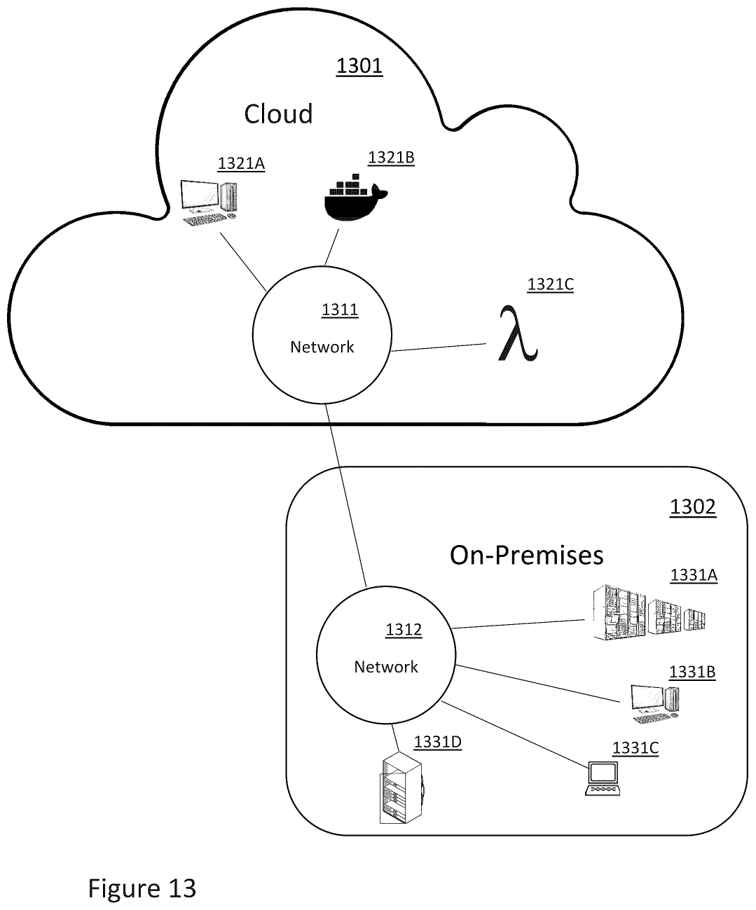

FIG. 13 is a conceptual illustration of on-premises network and cloud which are the context where an application executes, and the dynamic optimization enhances the application and cuts and sprays parts of the application over the resources. All part or any of resources on on-premises or cloud can be allocate as backend resource that the dynamic optimization uses, according to the preferred embodiment. Simply put, cloud 1301 computing is the delivery of computing services-including servers, storage, databases, networking, software, analytics.

Multiple on-premises 1331A, 1331B, 1331C (herein generically referred to as feature 1331) access respective computing services in cloud 101. A resource could be any digital data device capable of communicating with cloud over a network. For example, FIG. 13 represents a desktop computer system 1331B, a handheld portable device 1331C such as a laptop, personal digital assistant, smartphone, or the like, and a multi-user computer system 1331D having multiple terminals attached thereto. However, it will be understood that these examples are not exhaustive, and any of various alternative digital data devices could be used, that such devices might be single user or multiple users, might be general-purpose programmable digital computers or special purpose digital devices, could have fixed location or movable location (including vehicular mounted devices), and so forth.

From the perspective of on-premises resource, each on-premises resource device 1331A, 1331B, 1331C obtains computing services in cloud 1301 from a respective backend resource 1321A, 1321B, 1321C (herein generically referred to as feature 1321). Each backend resource 1321 appears to on-premises resource as a computer system having the computing resources requested (either explicitly or implicitly) by on-premises resource to perform computing services on behalf of on-premises resource. Since each on-premises resource is free to request services independently of any other on-premises resource, each backend resource 1321 does not necessarily include, and in general will not include identical computing resources and will not be configured in an identical manner.

Cloud network 1311 is a type of IT infrastructure in which some or all an organization's network capabilities and resources are hosted in a public or private cloud platform, managed in-house or by a service provider, and available on demand. The Virtual Desktop 1321A definition, or cloud desktop, is the following: a virtual environment where the entire desktop operating system with other software applications, are encapsulated into a software package and run as an instance on any compatible computer/server using virtual machine software.

Docker 1321B is an open-source containerization platform. It enables developers to package applications into containers-standardized executable components combining application source code with the operating system (OS) libraries and dependencies required to run that code in any environment. Lambda 1321C is a serverless, event-driven compute service that lets you run code for any type of application or backend service.

On-premises 1302 refers to IT infrastructure hardware and software applications that are hosted on-site. A data center 1331A is a facility that centralizes an organization's shared IT operations and equipment for the purposes of storing, processing, and disseminating data and applications. Because they house an organization's most critical and proprietary assets, data centers are vital to the continuity of daily operations. A server chassis 1331D is a metal structure that is used to house or physically assemble servers in various form factors. A server chassis makes it possible to put multiple servers and other storage and peripheral equipment in a single physical body.

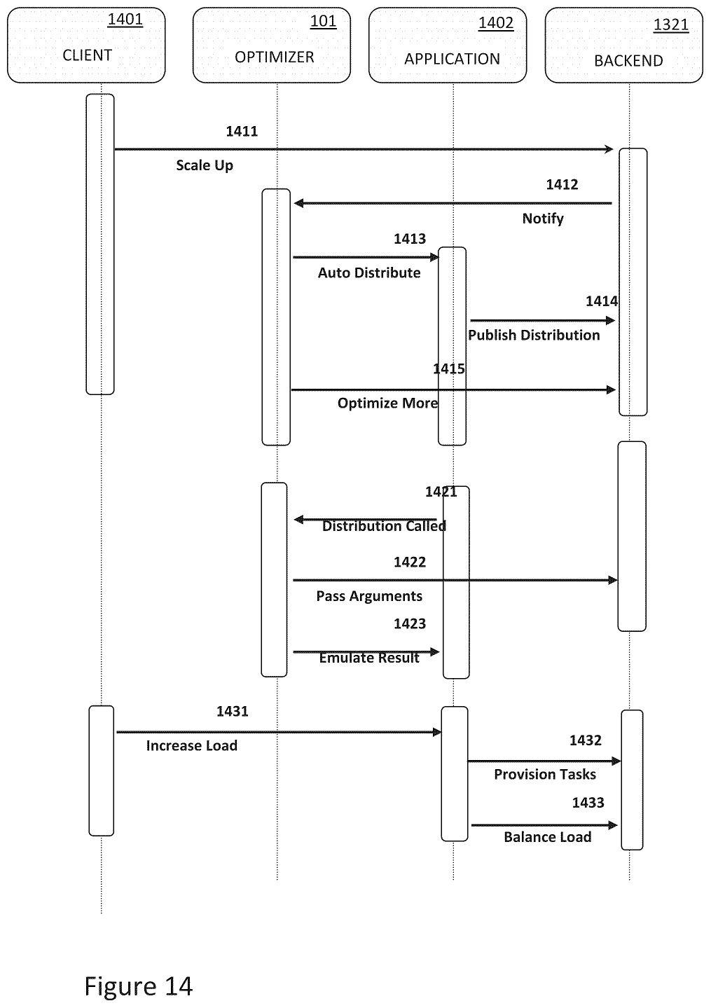

FIG. 14 is a flow diagram illustrating at an elevated level the process of changing the defining parameters of an application, optimizer, and backend resource. The application and optimizer are executing in cloud or in on-premises, according to the preferred embodiment. Client 1401 is a registered user in cloud or on-premises with identity and authentication to access cloud. The client 1401 can also be an automation script or application that is triggered somehow and manages the optimization and optimizer. This process involves interaction among client 1401, the optimizer 101 executing in either in cloud 1301 or in on-premises 1302, the application 1402 executing in the same computer base the optimizer is running, and the back end 1321 resource in cloud. Actions performed by each of these entities are depicted in the respective columns of FIG. 14, separated by vertical broken lines.

Referring to FIG. 10, a client 1401 scales up backend 1321 resource (arrow 1411). For example, it increases number of dockers 1321B, or amount of virtual CPU or memory for virtual server 1321A or increases computing power of serverless (lambda) 1321C resource. The optimizer 101 gets notified and starts optimizing target application 1402 even more since there are more computing power available. Optimization according to the preferred embodiment starts with auto-distribution. The optimizer cuts parts of the application and move them to backend resource. Then it performs other optimization on both original application and the distributed parts.

When a functionality of application 1402 is invoked and that function is not local, the application notifies the optimizer (arrow 1421). The optimizer calls the functionality where it is distributed (arrow 1422). Then it sets stack, variables, registers, and context of the application as the function ran locally as part of application.

Client increases load of the application for example by feeding it with larger file to process (arrow 1431). When the optimizer initially sets backend resource it sets some threshold for maximum number of processes and dockers it can provision, and the optimizer also sets the load balancer in the backend resource. In the case, the backend resource scales up without extra interference from the optimizer and the application will not be manipulated further.

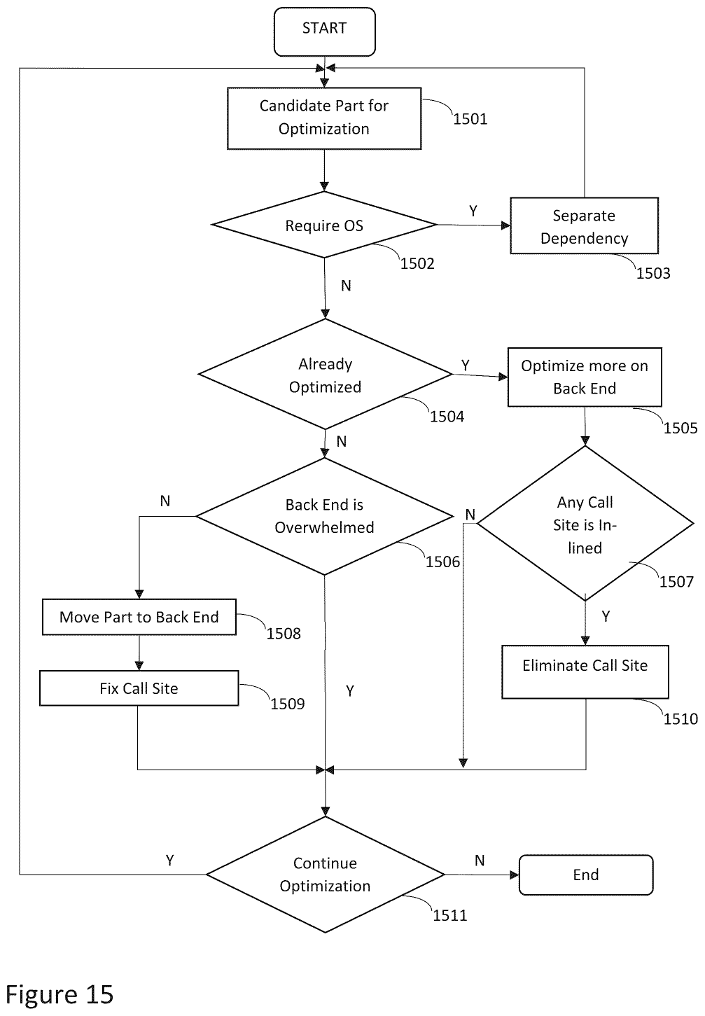

FIG. 15 is a flow diagram illustrating at an elevated level the operation of optimizing application increments the load of the backend resource, according to the preferred embodiment. In this embodiment, the optimizer starts with auto distribution and later perform further dynamic optimization. It will be understood order of dynamic optimization does not have to start with auto-distribution and dynamic optimizer 101 might only optimize target application where the application is executing without even moving any part of the application to the backend resource.

Referring to FIG. 15, the dynamic optimizer 101 chose part of the code as candidate for optimization (block 1501). According to the preferred embodiment, it can be a frequent method that is called many times or had long duration of execution at top of stack. Then it tests if the candidate has dependency to Operating System (block 1502), for instance, if it calls any Interrupt or catch any Signal. It tries to remove operating system dependency for instance splits the function into two functions, one OS independent (block 1503). If the code is the first time to be optimized (block 1504) and if the backend resource has enough resources left (block 1505), the optimizer performs auto-distribution (block 1508 and block 1509). If the code is already optimized, another round of optimization takes place (block 1505). One such optimization is in-lining methods deeper this may produce dead-code elimination optimization, including some of the methods that are in-lined, the call site on original application is not needed any more (block 1510).

1. A method to enhance the performance of a software application that is already compiled into native code and is already statically optimized by static compiler, comprising of:
a. starting the software application as a child process to have access to it for attaching, inspecting, and modifying it at run time,
b. disassembling the software application,
c. profiling the software application to collect statistics,
d. analyzing the software application to design optimization, power saving enhancements, robustness enhancements, or security enhancements, and combinations thereof; and,
e. just-in-time compiling the software application based on that optimization or enhancements.

2. The method of claim 1, wherein profiling comprises at least one strategy selected from the group comprising inspecting process and inserting probes in process.

3. The method of claim 1 wherein statistics comprises at least one class of statistics selected from the group comprising function frequency, loop count, invariants, variable types, memory allocation, memory deallocation, memory leak, networking, and filing.

4. The method of claim 3, wherein function frequency comprises at least one type selected from the group comprising function call count and how many times function is seen at intervals at top of stack.

5. The method of claim 3, wherein invariants comprise at least one type selected from the group comprising constants, invariants in loops, invariants in functions, variables that are invariants at some percentage of times.

6. The method of claim 1, wherein optimization comprises at least one action selected from the group comprising method in-lining, high-level classic optimization, low-level optimization, trace optimization, distribution, parallelization, conversion to FPGA, and resource management enhancements.

7. The method of claim 6, wherein high-level classic optimization comprise at least one optimization selected from the group comprising method in-lining, induction variable, peephole, common expression elimination, constant folding, copy propagation, dead code elimination, code motion, and loop unrolling.

8. The method of claim 6, wherein low-level optimization comprise at least one optimization selected from the group comprising register allocation, scheduling, vectorization, and machine idioms.

9. The method of claim 6, wherein trace optimization comprises selecting a path of code and ensuring code may enter only at beginning and exit only and end and no execution can exit and enter the path in middle.

10. The method of claim 9, wherein ensuring code may enter only at beginning and exit only and end comprises at least one action selected from the group comprising clone path, unroll loops along trace, put required restriction at entry, eliminate all exits, put guards along trace.

11. The method of claim 9, wherein selecting a path comprises preferably connecting trace to one of other traces.

12. The method of claim 6, wherein parallelization comprises threading methods and/or traces in process and preferably reducing synchronization between the threads and the process.

13. The method of claim 6, wherein distribution comprises generating new process, moving part of application to new process, providing communication between new process and original application, and reducing synchronization due to the communication.

14. The method of claim 6, wherein resource management comprise at least one management selected from the group comprising management of network sockets, management of database handles, management of user interaction windows, management of file/device descriptions, and memory management.

15. The method of claim 14, wherein memory management comprises at least one management selected from the group comprising garbage collection, exploiting locality, optimization regarding memory hierarchy, reducing fragmentation, speeding up allocation/deallocation, and compressing memory.

16. The method of claim 1, wherein power saving comprise at least one action selected from the group comprising reducing memory footprint and memory compression.

17. The method of claim 1, wherein robustness enhancements comprise at least one action selected from the group comprising garbage collection, dead lock detection/resolution, and defect detection.

18. The method of claim 1, wherein security enhancements comprise encrypting memory.

19. A computer-based system that comprises methods steps of claim 1.

20. The computer-based system of claim 19 may be connected to on-premises system and through that connected to cloud system.

21. The computer-based system of claim 19 may be connected to cloud system and through that connected to on-premises system.

22. The computer-based system of claim 20, wherein other computer-based system in on-premises or cloud comprises hosting new processes that are generated in method of claim 13.

23. The computer-based system of claim 21, wherein other computer-based system in on-premises or cloud comprises hosting new processes that are generated in method of claim 13.

24. The method of claim 1, wherein analysis comprising measure how much resource is available in on-premises or cloud and how much the resource is utilized.

25. The method of claim 24, wherein if the resources are too low and if they are too much utilized some of optimization of claim 6 may be reversed and deoptimization takes place.
